(19) United States
(12) Patent Application Publication
(10) Pub. No.: US 2018/0253672 A1
(43) Pub. Date: Sep. 6, 2018

(54) SYSTEMS AND METHODS FOR MONITORING APPLICATIONS DISTRIBUTED BY A SOFTWARE DISTRIBUTION PLATFORM

(71) Applicant: MacPaw Inc., Santa Clara, CA (US)

(72) Inventor: Oleksandr Kosovan, Kiev (UA)

(21) Appl. No.: 15/448,048

(22) Filed: Mar. 2, 2017

(51) Int. Cl. G06Q 10/06

(52) U.S. Cl. CPC G06Q 10/06313

(57) ABSTRACT

A method for monitoring an application managed by an application delivery system includes: generating a launch notification when the application is launched; reporting a launch event to a resource distribution system; monitoring for a notification from the application; reporting an additional event to the resource distribution system based on the notifications from the application; and calculating a resource share for the application based at least in part on the additional event reported to the resource distribution system.

### BACKGROUND

### Technical Field

Aspects of the present disclosure relate to software distribution platforms and more particularly to systems and methods for monitoring applications distributed by a software distribution platform.

### Related Art

Software distribution platforms typically use either one-time purchase or subscription-based monetization approach. The one-time purchase monetization model is traditional and widely spread. It allows a developer to obtain a comparably bigger revenue, but only once for a certain product. In order to generate more income, the developer has to either develop new products or apply some marketing techniques which require additional expenses and generally frustrates users.

Selling subscriptions can be more advantageous as it provides a continuous revenue flow, for example on a monthly or yearly basis. This approach is popular among owners of software distribution platforms, although its revenue sharing model still has drawbacks. In particular, if a developer is promised a fixed portion of the subscription price, the developer cannot expect to receive a larger portion even if the application becomes more frequently used than other applications.

Calculating a share of profit based on the time spent by users within an application may be more beneficial from this perspective. However, applications may bring different types of value. For example, while some applications may be launched on a daily basis and used for hours (e.g., email clients), others may be used only once in a month (e.g., system utilities). Therefore, splitting revenue using this method may be disadvantageous for some types of applications.

In general, existing revenue sharing methods have a number of shortcomings that can be improved. The most evident shortcomings are fixed shares in revenue and failing to account for the specificity of some application (for example, small applets that provide only indications functionality) in time-based revenue sharing methods.

### SUMMARY

Systems and methods for monitoring applications distributed by a software distribution platform and sharing resources among developers of the applications distributed by the software distribution platform are provided.

According to various aspects there is provided a method for monitoring an application managed by an application delivery system. In some aspects, the method may include: generating a launch notification when the application is launched; reporting a launch event to a resource distribution system; monitoring for a notification from the application; reporting an additional event to the resource distribution system based on the notifications from the application; and calculating a resource share for the application based at least in part on the additional event reported to the resource distribution system.

According to various aspects there is provided a system for monitoring managed applications. In some aspects, the system may include: an application delivery system configured to manage a plurality of applications developed by one or more developers; a tracking and reporting system in communication with the application delivery system and configured to receive notifications from the plurality of applications; and a resource distribution system in communication with the tracking and reporting system, the resource distribution system configured to calculate a resource share for each of the plurality of applications based at least in part on events reported by the tracking and reporting system. The events may be based on the notifications received by the tracking and reporting system.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1 is a schematic diagram of a software distribution environment in accordance with various aspects of the present disclosure;

FIG. 2 is a flowchart illustrating a method for monitoring and reporting application usage events in accordance with various aspects of the present disclosure;

FIG. 3 is a table illustrating an example of resource sharing calculations in accordance with various aspects of the present disclosure; and

FIG. 4 is a block diagram illustrating an example computer environment with an example computing device associated with the software distribution environment in accordance with various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

The various aspects of the present disclosure relate to systems and methods for monitoring applications distributed by a software distribution platform and sharing resources generated within a subscription-based content distribution platform. In the various aspects, resources consist of subscription fees that users pay with a certain periodicity to access multiple software applications (referred to throughout this disclosure interchangeably as “applications” and/or “software applications”) placed by various developers on a unified distribution platform. Alternative implementations of aspects of the present disclosure may include distribution of various digital content, for example, but not limited to, software applications, games, music, videos, books, images. The various aspects of the present disclosure may be implemented as part of one-time purchase, or any other combined or stand-alone monetization model that is compatible with the described resource sharing approach.

Embodiments of the present disclosure may be used in, for example, but not limited to, a software distribution platform where users are periodically billed a certain subscription fee for unlimited access to applications available on the platform. Thus, users may pay a fixed fee for access to all applications rather than paying separate fees for accessing individual applications. In accordance with aspects of the present disclosure, the fixed fee may be apportioned among developers according to usage of the applications available on the platform. However, aspects of the present disclosure may be implemented within other distribution platforms with customized conditions of content usage and payment.

Embodiments of the present disclosure may replace the conventional fixed resource distribution model with a dynamic resource distribution model, where a developer's share in revenue may vary depending on delivered usage values of the developer's application, a total number of applications used by a particular user account, and price coefficients of the used applications.

To establish the delivered usage value, the preferred embodiment of the resource sharing method uses regular event-based reporting of application usage statistics. A tracking and reporting system monitors notifications and changes in statuses of an application, and then reports the notifications and changes in statuses to a resource distribution system in the form of corresponding events (for example, but not limited to, opening or quitting of the applications).

At the end of a subscription period, all reports from every user account are processed to define which applications were used by a particular user. In other words, all application usage data is processed for each user account separately, and shares in resources for each developer are further calculated separately per each user's subscription fee.

Unlike the time-based subscription model, the presently disclosed systems and methods do not take into account time spent by the user within an application. On the contrary, the fact of usage itself is considered sufficient. Therefore, the aspects of the present disclosure address at least one of the key drawbacks of the traditional time-based revenue sharing method and may equalize different types of applications in terms of the revenue sharing process.

According to various aspects of the present disclosure, an application is considered used if the application's usage data contains certain application behavior patterns. An application behavior pattern is a predefined combination of usage events that confirms the fact of application usage. Application behavior patterns may be determined by the resource distribution system during processing of application-related usage data. The application behavior patterns may vary depending on a type of an application. For example, an application that runs in a separate window and requires no additional authorization is considered used if a user opened the application and took some action within the application.

The resource distribution system may detect the application behavior patterns (i.e., event combinations) for various types of applications including, but not limited to: for regular applications, an ‘activate’ event that is followed by any other event with a certain delay and a ‘heart-beat-active’ event that is followed by any other event with a certain delay; for active applets, any event that is followed by any other event with a certain delay; for passive applets: at least two ‘user-interaction’ events; and for applications that require authorization: a ‘sign-in’ event that is followed by any other event with a certain delay. One of ordinary skill in the art will appreciate that behavior patterns may vary in other aspects of the presently disclosed systems and methods.

In accordance with various aspects of the present disclosure, one event may be sufficient to establish the fact of usage of the application. Thus, the resource distribution system may detect the one event and take the fact of usage into account in the distribution of profits.

As stated above, calculations within various aspects of the resource sharing method may take into account a number of applications used by a particular user. The more applications are used during the subscription period, the less is a resource share of each developer. In other words, each subscription fee of each user is split proportionally among all developers of used application based on price coefficients of the various applications.

This method allows a developer to get a bigger portion of resources if a user worked with the developer's application along with only a few other applications and/or if the price coefficient of the developer's application is higher than a price coefficient of other used applications. These factors may provide for even higher flexibility of the described resource sharing method compared to the traditional subscription revenue sharing.

Various aspects of the present disclosure may use a price coefficient to assess an application's market value compared to other applications. One of ordinary skill in the art will appreciate that this is only one of many possible methods for assessing the market value of an application, and various aspects of the present disclosure may use other methods, for example, but not limited to, a price coefficient based on a current market price for the application.

Various aspects of the present disclosure may group applications into so-called price tiers that are tied to certain price coefficients. A price coefficient may be used in calculations of the disclosed resource sharing method and may directly affect the total amount of resources assigned to a developer.

Various aspects of the present disclosure address drawbacks of a traditional one-time purchase revenue sharing system and improve subscription-based revenue methods. Unlike the prior art, aspects of the present disclosure take into account neither a number of usages of a particular application nor time spent within the application. Rather, only the fact of usage is considered thereby enabling adjusting of resource shares depending on the statistics of application usage. Thus, the disclosed systems and methods equalize the terms of resource distribution for applications used only once in a subscription period and for applications used on a daily basis.

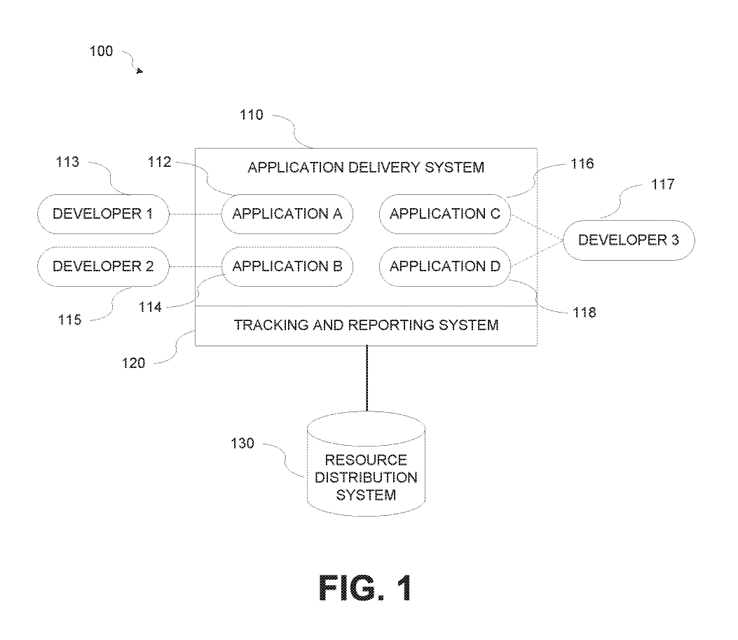

FIG. 1 is a schematic diagram of a software distribution environment 100 in accordance with various aspects of the present disclosure. Referring to FIG. 1, the software distribution environment may include at least two main components: an application delivery system 110 and resource distribution system 130. The application delivery system 110 may be a client application that may be installed on any operating system that is adapted to use on computing devices, for example, but not limited to, desktop computers, mobile devices, laptops, tablets, and other electronic devices that can establish network connections. The resource distribution system 130 may reside on a server.

The application delivery system 110 may manage multiple applications developed by multiple developers. In particular, the application delivery system may enable, for example, but not limited to, preview, download, installation, configuration, removal, and/or update of applications 112, 114, 116, 118 provided by a variety of developers, for example developer 1 113, developer 2 115, and/or developer 3 117. In accordance with various aspects of the present disclosure, some implementations may use a modified application delivery system or alternative embedded in-application management and reporting technologies.

A tracking and reporting system 120 of the software distribution environment may monitor changes in states of applications managed by the platform and may receive notifications generated by these applications to report corresponding events to the resource distribution system 130. For example, events may be reported on opening and quitting of an application, return of an application window to a frontmost position on the display, minimization or going to background of an application window, sign-in/sign-out, and/or user-interaction (e.g., clicking on the icon, calling a shortcut menu). One of ordinary skill in the art will appreciate that any other changes in an application's status may be tracked and reported by the tracking and reporting system 120 without departing from the scope of the present disclosure. In addition, the tracking and reporting system 120 periodically monitors which applications are currently launched and sends corresponding heartbeat events (i.e., active/inactive) to the resource distribution system 130.

These events may be periodically reported to the resource distribution system 130 by the tracking and reporting system 120 via a wireless or wired network connection. Applications may generate notifications by any method known to those of skill in the art. The resource distribution system 130 may accumulate all usage data reported by the tracking and reporting system 120, process the data, and perform calculation and distribution of resources in accordance with the results of application usage reporting.

In accordance with various aspects of the present disclosure, applications that are managed by the application delivery system 110 include a notification library. The notification library enables automatic generation of notifications when the status of the application changes. One of ordinary skill in the art will appreciate that the notification functionality may be implemented in any other way without departing from the scope of the present disclosure.

Aspects of the disclosed resource sharing method allocate each subscription fee among developers of applications based on at least (a) a usage statistic of the application, (b) price coefficient of the application, and (c) number of applications used by every particular user. The usage statistic is application-related data obtained from every user of the application delivery system 110 during a current subscription period. The application-related data is based on the event-based reports that describe changes in status of each application that is used during the period. This data may be processed by the revenue distribution system 130 to establish the fact of application usage. In particular, the revenue distribution system 130 searches for predefined combinations of usage events that indicate a certain behavior pattern. If the combination of usage events (i.e., the application behavior pattern) is found, the application is considered used in the current subscription period.

The fact of application usage may be determined per each user separately based on reported usage data. Application usage data includes events that are reported when the status of an application changes, or when the application sends some notifications to the system or user. In particular, the tracking and reporting system 120 may create and report a corresponding event to the resource distribution system 130, when a user opens an application, for example application A 112, application B 114, application C 116, or application D 118. The tracking and reporting system 120 may continue to monitor the application and report the corresponding event if the application is quit. In accordance with various aspects of the present disclosure, one event may be sufficient to establish the fact of usage of the application.

If the user works with the application or its window returns in the front-most position on the display the tracking and reporting system 120 may report the corresponding event. Otherwise, when the application window is minimized or moves to background (i.e., assumes a position behind other windows on the display), the tracking and reporting system 120 reports the corresponding event.

Every launched application managed by the application delivery system 110 sends a timeout notification once in a predetermined period. The tracking and reporting system 120 may determine whether the application that sent the timeout notification is subsequently in use. If the application is subsequently in use, the tracking and reporting system 120 may send a report with heartbeat-active event. Otherwise, if the application is currently idle, the tracking and reporting system 120 may send a report with heartbeat-inactive event. If the application is timed out, the tracking and reporting system 120 verifies whether the application is active and starts sending ‘heartbeat’ reports of the corresponding type (i.e., active or inactive). In accordance with various aspect of the present disclosure, instead of receiving a timeout notification, the tracking and reporting system 120 may periodically check, for example every hour, which applications are launched and send corresponding ‘heartbeat’ reports.

Like any other events, ‘heartbeat’ events may be processed by the resource distribution system 130 to determine certain application behavior patterns and thus establish the fact of application usage. In other words, heartbeat-active and heartbeat-inactive events, being a part of certain event combination, may prove the fact of application usage. For example, during processing of events obtained from of a regular application, the resource distribution system 130 determined the following event combination: the application reported a ‘heart-beat-active’ event that was followed by a ‘termination’ event with a 2-minute delay. This event combination may comply with a predefined application behavior pattern for regular applications. Thus, the fact of application usage is considered established.

However, reporting of the events described above reveals only behavior patterns of regular applications. According to various aspects of the disclosure, some types of applications require detecting additional, ‘custom’, events to confirm that the user received a certain value. In particular, aspects of the present disclosure may distinguish, but are not limited to, the following types of applications:
regular applications, which are stand-alone applications that run in separate windows and require no additional authorization;
applications that require authorization to give access to their main functionality;
applets (small applications, for example, but not limited to, macOS™ menu bar extras or widgets), which most of the time remain dormant and provide some indication, visual content, notifications, or quick ways to use some valuable features.

The event-based usage reporting method may additionally divide applets into active applets and passive applets. Active applets constantly or periodically deliver some value to a user with no need for additional interactions. Active applets may present some indication or notification functionality, for example, but not limited to, weather apps. Passive applets may provide some quick functionality but may be idle most of the time.

Applets and applications with obligatory authorization may report additional usage events due to specifics of their functioning. For example, if an application gives access to its main functionality only after sign-in, a user does not get any value after simply launching this application. Thus, receiving the launch event may not be enough to consider the application used. Accordingly, the tracking and reporting system 120 may also monitor the application for various custom notifications and report the custom notifications as events.

Custom events may include but are not limited to:
sign-in event—reported after a user has signed in to the application, or right after the launch of the application if the user is already signed in;
sign-out event—reported after a user has signed out from the application;
user-interaction event—valid for applets; reported after a user has activated the application by clicking on its icon, calling its shortcut menu, or by any other way.

To ensure fair resource sharing, the tracking and reporting system 120 may also report some other events that are not described in this document.

At the end of the subscription period, all events from every user reported by the tracking and reporting system 120 are processed by the resource distribution system 130 to determine applications that were used and delivered some value to a user. In accordance with various aspects of the present disclosure, value may be considered ‘delivered’ if the resource distribution system 130 has indicated a certain combination of events. The combination of events may differ depending on a type of the application. One of ordinary skill in the art will appreciate that alternative implementations of aspects of the present disclosure may provide other ways of determining appropriate application behavior patterns.

The resource distribution system 130 may process received usage data to filter out the following event combinations:
for regular applications:

an ‘activate’ event that is followed by any other event with a certain delay;
a ‘heart-beat-active’ event that is followed by any other event with a certain delay;
for active applets: any event that is followed by any other event with a certain delay;
for passive applets: at least two ‘user-interaction’ events;
for applications that require authorization: a ‘sign-in’ event that is followed by any other event with a certain delay.

According to various aspects of the present disclosure, if the resource distribution system 130 receives reports of at least one of the described above event combinations, the application may be considered used. Alternatively, reports of at least one event may be sufficient to establish the fact of usage of the application. According to various aspects of the present disclosure, the usage data from every user account is processed separately by the resource distribution system 130 for each application. One of ordinary skill in the art will appreciate that other implementations may use other events, event combinations, a single event, or application behavior patterns to prove the fact of delivered value. Also, other implementations of aspects of the present disclosure may include processing of usage data per group of users or per group of applications, or may include using an event-based usage reporting method modified in some other way without departing from the scope of the present disclosure.

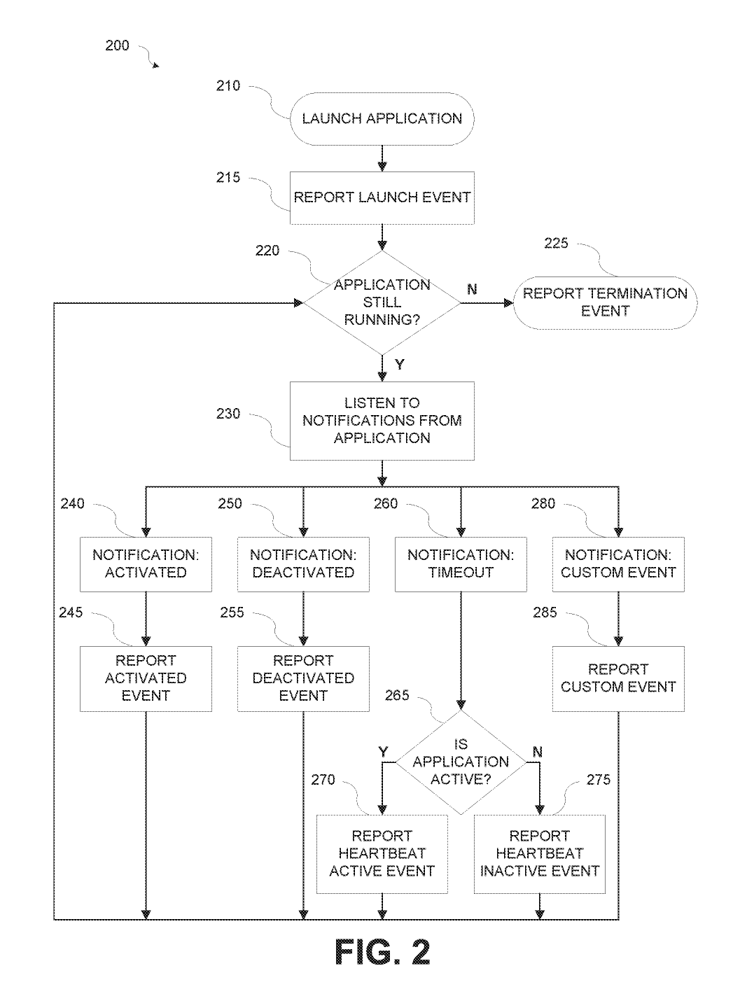

FIG. 2 is a flowchart illustrating a method 200 for monitoring and reporting application usage events in accordance with various aspects of the present disclosure. Referring to FIGS. 1 and 2, at block 210 an application managed by the application delivery system 110 may be launched on a user device and a launch notification may be received from the application by the tracking and reporting system 120. The application may be a regular application, an application requiring authorization, or an applet. At block 215, the launch event may be reported to the resource distribution system 130 by the tracking and reporting system 120. For example, the tracking and reporting system 120 may report the launch event to the resource distribution system 130 running on a server via a wireless or wired network connection. In accordance with various aspects of the present disclosure, one event, for example but not limited to the launch event, may be sufficient to establish the fact of usage of the application.

At block 220, it may be determined whether the application is still running. For example, the tracking and reporting system 120 may track the status of the application and determine whether the application is running. In response to determining that the application is not running (220-N), at block 225 the tracking and reporting system 120 may report a termination event to the resource distribution system 130. In response to determining that the application is still running (220-Y), at block 230 the tracking and reporting system 120 may monitor for notifications from the application. The tracking and reporting system 120 may receive one or more of several notifications from the application: an activated notification, a deactivated notification, a timeout notification, and a custom event notification.

At block 240, the tracking and reporting system 120 may receive an activated notification from the application. For example, the tracking and reporting system 120 may receive an activated notification when a user works with the application or the application window returns to the front-most position on the display. At block 245, the tracking and reporting system 120 may report an activated event for the application to the resource distribution system 130 based on receipt of the activated notification. The method may continue at block 220 with the tracking and reporting system 120 monitoring the application.

At block 250 the tracking and reporting system 120 may receive a deactivated notification from the application. For example, the tracking and reporting system 120 may receive a deactivated notification when the application window is minimized or moved to background (i.e., assumes a position behind other windows on the display). At block 255, the tracking and reporting system 120 may report a deactivated event for the application to the resource distribution system 130 based on receipt of the deactivated notification. The method may continue at block 220 with the tracking and reporting system 120 monitoring the application.

At block 260 the tracking and reporting system 120 may receive a timeout notification from the application. Alternatively, the tracking and reporting system 120 may periodically check whether the application is active without receiving a timeout notification. At block 265, the tracking and reporting system 120 may determine whether the application is active. In response to determining that the application is active (265-Y), at block 270 the tracking and reporting system 120 may report a heartbeat active event to the resource distribution system 130 based on receipt of the timeout notification. In response to determining that the application is not active (265-N), at block 275 the tracking and reporting system 120 may report a heartbeat inactive event to the resource distribution system 130 based on receipt of the timeout notification. In either case, the method may continue at block 220 with the tracking and reporting system 120 monitoring the application.

At block 280 the tracking and reporting system 120 may receive a custom event notification from the application. For example, the tracking and reporting system 120 may receive a sign-in event after a user has signed in to the application or right after the launch of the application if the user is already signed in, or a sign-out event after a user has signed out from the application. If the application is an applet, the tracking and reporting system 120 may receive a user-interaction event after a user has activated the application, for example, by clicking on its icon, calling its shortcut menu, or by any other way.

At block 285, the tracking and reporting system 120 may report a custom event for the application to the resource distribution system 130 based on receipt of the deactivated notification. The method may continue at block 220 with the tracking and reporting system 120 monitoring the application.

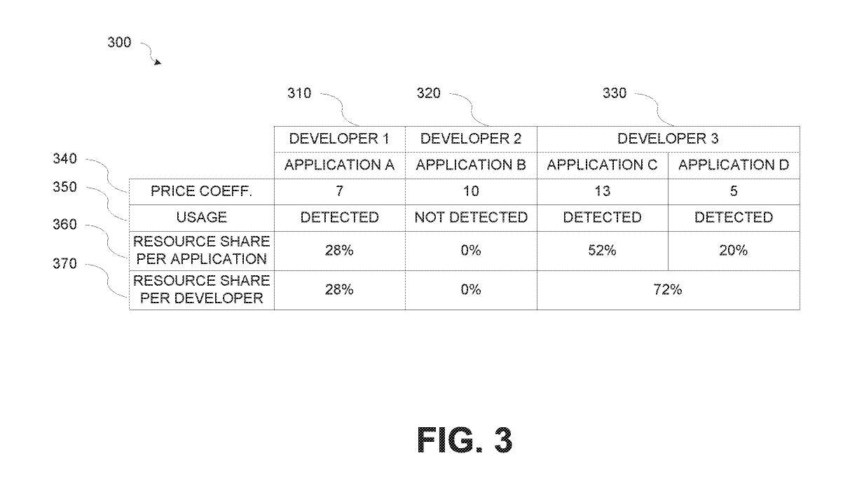

FIG. 3 is a table 300 illustrating an example of resource sharing calculations in accordance with various aspects of the present disclosure. In FIG. 3 an example of resource sharing is provided based on usage data obtained from one user who had access to four applications provided by three developers. One of ordinary skill in the art will appreciate that the data represented in FIG. 3 are merely exemplary and that alternative implementations of aspects of the present disclosure may not use a price coefficient in resource calculations, and further that a market value of an application must be considered in any other appropriate way.

Referring to FIGS. 1, 2, and 3, according to table 300 in FIG. 3, exemplary application price coefficients 340 for the applications may be:

Application A from Developer 1 310 has price coefficient 7;

Application B from Developer 2 320 has price coefficient 10;

Application C from Developer 3 330 has price coefficient 13; and

Application D from Developer 3 330 has price coefficient 5.

With regard to usage 350, the tracking and reporting system 120 has not detected any appropriate behavior pattern that confirms usage for the Application B from Developer 2 320. Therefore, Application B is considered unused in the sample subscription period. Thus, all resource-sharing calculation are carried out only for the three used applications, i.e., Application A from Developer 1 310 and Applications C and D from Developer 3 330.

In accordance with various aspects of the present disclosure, the resource distribution system 130 may use the following formula to calculate a resource share per application 360:

$$Resource Share per application = 100 \% \cdot \frac{application coefficient}{sum of coefficients of all used applications}$$

where the application price coefficient 340 is a predefined coefficient that reflects a value of the application.

Thus, the resource distribution system 130 may perform the following calculations to determine resource shares per application 360:

$$Resource Share Application A = 100 \% \cdot \frac{7}{7 + 13 + 5} = 28 \%$$

$$Resource Share Application C = 100 \% \cdot \frac{13}{7 + 13 + 5} = 52 \%$$

$$Resource Share Application D = 100 \% \cdot \frac{5}{7 + 13 + 5} = 20 \%$$

Accordingly, the resource distribution system 130 may calculate the resource share per developer 370:

Resource Share for Developer 1=28% (for Application A); and

Resource Share for Developer 3=52%+20%=72% (for Applications C and D).

The various aspects of the present disclosure enable dynamic adjustment of a developer's resource share depending on the real usage value of the application delivered in a given subscription period and the application's current market value.

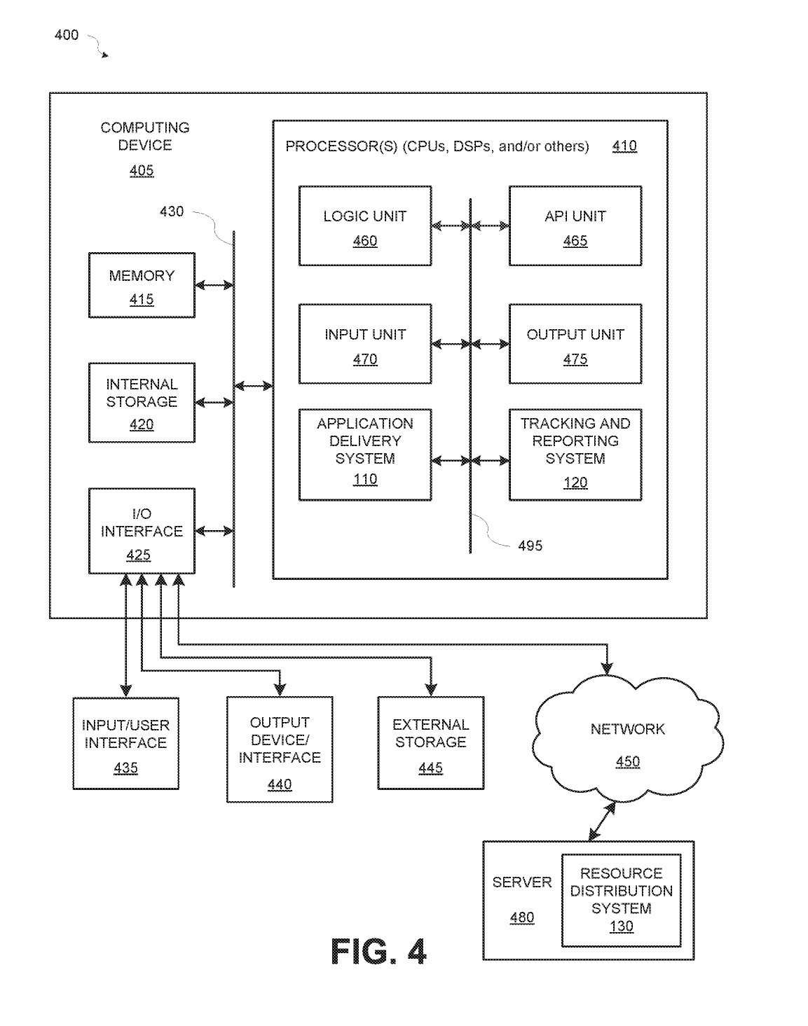

FIG. 4 is a block diagram illustrating an example computing environment 400 with an example computing device 405 associated with the software distribution environment in accordance with various aspects of the present disclosure. The computing environment 400 may include a computing device 405 and a server 480. The resource distribution system 130 may be deployed on the server 480. The server 480 may communicate with the computing device 405 via a network 450.

The computing device 405 may be, for example, a user device. The computing device 405 may include one or more processing units, cores, or processors 410, memory 415 (e.g., RAM, ROM, and/or the like), internal storage 420 (e.g., magnetic, optical, solid state storage, and/or organic), and/or I/O interface 425, any of which can be coupled on a communication mechanism or bus 430 for communicating information or embedded in the computing device 405. The memory 415 and/or the internal storage 420 may be configured to store operating systems and/or application programs for operation of the computing device 405 that are executed by the one or more processing units, cores, or processors 410, as well as to store application data and user data.

The computing device 405 may be communicatively coupled to an input/user interface 435 and an output device/interface 440. Either one or both of the input/user interface 435 and the output device/interface 440 may be a wired or wireless interface and can be detachable. The input/user interface 435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). The output device/interface 440 may include a display, television, monitor, printer, speaker, braille, or the like. In some example implementations, the input/user interface 435 and the output device/interface 440 may be embedded with or physically coupled to the computing device 405. In other example implementations, other computing devices may function as or provide the functions of the input/user interface 435 and the output device/interface 440 for the computing device 405.

Examples of the computing device 405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

The computing device 405 can be communicatively coupled (e.g., via the I/O interface 425) to external storage 445 and a network 450 for communicating with any number of networked components, devices, and systems, including one or more computing devices of the same or different configuration. The computing device 405 or any connected computing device can be functioning as, providing services of, or referred to as a server, client, thin server, general machine, special-purpose machine, or another label.

The I/O interface 425 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

The I/O interface 425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in the computing environment 400. The network 450 can be any network or combination of networks (e.g., the Internet, local area network, wide area network, a telephonic network, a cellular network, satellite network, and the like).

The computing device 405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

The computing device 405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

The processor(s) 410 can execute under any operating system (OS) (not shown), in a native or virtual environment. One or more applications may be deployed that may include a logic unit 460, an application programming interface (API) unit 465, an input unit 470, an output unit 475, the application delivery system 110, and the tracking and reporting system 120. For example, the application delivery system 110 and the tracking and reporting system 120 may execute one or more processes shown in FIG. 2. The described units and elements can be varied in design, function, configuration, or implementation and are not limited to the descriptions provided.

In some example implementations, when information or an execution instruction is received by API unit 465, it may be communicated to one or more other units (e.g., the logic unit 460, the input unit 470, the output unit 475, the application delivery system 110, and the tracking and reporting system 120).

For example, after input unit 470 has received input from a user, such as an instruction to launch or quit an application or other such user interaction for an application managed by the application delivery system 110, input unit 470 may use API unit 465 to communicate a launch notification or other event notification to the tracking and reporting system 120.

In some instances, logic unit 460 may be configured to control the information flow among the units and direct the services provided by the API unit 465, the input unit 470, the output unit 475, the application delivery system 110, and the tracking and reporting system 120. For example, the flow of one or more processes or implementations may be controlled by logic unit 460 alone or in conjunction with API unit 465.

The method 200 may be embodied on a non-transitory computer readable medium, for example, but not limited to, the memory 415, the internal storage 420, or other non-transitory computer readable medium known to those of skill in the art, having stored therein a program including computer executable instructions for making a processor, computer, or other programmable device execute the operations of the methods.

The example implementations may have various benefits and advantages. For example, but not by way of limitation, enhanced tracking of the fact of application usage to enable more equitable resource sharing among developers of software managed by the application delivery.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A method for monitoring an application managed by an application delivery system, the method comprising:
generating a launch notification when the application is launched;
reporting a launch event to a resource distribution system;
monitoring for a notification from the application;
reporting an additional event to the resource distribution system based on the notification from the application; and
calculating a resource share for the application based at least in part on the additional event reported to the resource distribution system.

2. The method of claim 1, wherein the notification from the application comprises one or more of an activated notification, a deactivated notification, a timeout notification, and a custom event notification.

3. The method of claim 2, wherein the custom event notification comprises at least one of a sign-in notification, a sign-out notification, and a user-interaction notification.

4. The method of claim 1, wherein usage of the application is determined at least in part based on a behavior pattern determined from the additional event reported to the resource distribution system.

5. The method of claim 1, wherein usage of the application is determined at least in part based on only one event reported to the resource distribution system.

6. The method of claim 1, wherein the resource share for the application is calculated based at least in part on a coefficient assigned to the application.

7. The method of claim 6, wherein the coefficient is an indication of a value of the application.

8. The method of claim 1, wherein the resource share for the application is calculated based on usage of the application determined at least in part based on the additional event reported to the resource distribution system.

9. The method of claim 1, wherein the resource share for the application is calculated over a period.

10. The method of claim 1, wherein the calculating a resource share for the application does not take into account time spent by a user within the application.

11. The method of claim 1, further comprising monitoring a first plurality of applications developed by a second plurality of developers.

12. The method of claim 11, wherein the resource share for each application of the first plurality of applications is calculated based on usage of each application with respect to overall usage of the first plurality of applications.

13. The method of claim 12, wherein each of the first plurality of applications is assigned a coefficient.

14. The method of claim 13, wherein the coefficient is an indication of a value of each application.

15. The method of claim 13, wherein the resource share for each application of the first plurality of applications is calculated based at least in part on the coefficient assigned to each application with respect to a total of all coefficients assigned to the first plurality of applications.

16. The method of claim 12, wherein the resource share for each application of the first plurality of applications is calculated over a period.

17. The method of claim 12, wherein the calculating the resource share for each application of the first plurality of applications does not take into account time spent by a user within each application.

18. The method of claim 12, wherein a resource share for each developer of the second plurality of developers is a sum of resource shares of each application of the first plurality of applications developed by the developer.

19. The method of claim 12, wherein the resource share for each developer of the second plurality of developers is calculated over a period.

20. A system for monitoring managed applications, the system comprising:
an application delivery system configured to manage a plurality of applications developed by one or more developers;
a tracking and reporting system in communication with the application delivery system and configured to receive notifications from the plurality of applications; and
a resource distribution system in communication with the tracking and reporting system, the resource distribution system configured to calculate a resource share for each of the plurality of applications based at least in part on events reported by the tracking and reporting system,
wherein the events are based on the notifications received by the tracking and reporting system.

21. The system of claim 20, wherein the application delivery system and the tracking and reporting system are deployed on a user device.

22. The system of claim 21, wherein the resource distribution system is deployed on a server.

23. The system of claim 22, wherein the application delivery system and the tracking and reporting system deployed on the user device communicate with the resource distribution system deployed on the server via a network.

24. The system of claim 20, wherein the notifications from each of the plurality of applications received by the tracking and reporting system comprise one or more of an activated notification, a deactivated notification, a timeout notification, and custom event notifications.

25. The system of claim 24, wherein the custom event notifications comprise at least one of a sign-in notification, a sign-out notification, and a user-interaction notification.

26. The system of claim 20, wherein the resource distribution system determines application usage for each of the plurality of applications based at least in part on behavior patterns determined from the events reported to the resource distribution system.

27. The method of claim 20, wherein the resource distribution system determines application usage for each of the plurality of applications based on only one event reported to the resource distribution system by an application.

28. The system of claim 20, wherein the resource distribution system calculates the resource share for each of the plurality of applications based at least in part on a coefficient assigned to each of the plurality of applications.

29. The system of claim 28, wherein the coefficient is an indication of a value of each of the plurality of applications.

30. The system of claim 20, wherein the resource distribution system calculates the resource share each of the plurality of applications based at least in part on a coefficient assigned to an application with respect to a total of all coefficients assigned to the plurality of applications.

31. The system of claim 30, wherein the coefficient is an indication of a value of each of the plurality of applications.

32. The system of claim 20, wherein the resource distribution system calculates the resource share for each of the plurality of applications based on usage of each of the plurality of application determined at least in part based on the events reported to the resource distribution system.

33. The system of claim 32, wherein the resource distribution system calculates the resource share for each of the one or more developers as a sum of resource shares of each application of the plurality of applications developed by a developer.

34. The system of claim 20, wherein the resource distribution system calculates the resource share for each of the plurality of applications over a period.

35. The system of claim 20, wherein the resource distribution system calculates the resource share for each of the plurality of applications without taking into account time spent by a user within the application.
